(19) United States
(12) Patent Application Publication
(10) Pub. No.: US 2008/0256991 A1
(43) Pub. Date: Oct. 23, 2008

(54) Container Lock and Seal

(75) Inventor: Ilan Goldman, Herzliya (IL)

Correspondence Address: NATH & ASSOCIATES, 112 South West Street, Alexandria, VA, 22314, US

(73) Assignee: E-Lock Technologies Ltd, Hong Kong (CN)

(21) Appl. No.: 11/664,020

(22) PCT Filed: Sep. 26, 2005
(86) PCT No.: PCT/IL2005/001025

§ 371 Date: Jan. 18, 2008

Related U.S. Application Data
(60) Provisional application No. 60/613,512, filed on Sep. 28, 2004.

(51) Int. Cl. E05B 65/00

(52) U.S. Cl. 70/57.1; 70/77

(57) ABSTRACT

Locks and seals for containers, in particular those including an automatic self-checking and warning system against tampering, are provided. The lock has an infra-red (IR)-bases mechanism, with an IR emitter and an IR receiver, communicating through a waveguide such that an IR pulse emitted by the IR emitter can pass through the waveguide and be received by the IR receiver only when the lock is in the closed state. The seal has a U-shaped shackle engaged in a seal body irreversibly locking said shackle to the body. Only when the shackle is broken into two separate parts, each part can be rotated to disengage the cylindrical end so that the broken part may be pulled out of the body.

### FIELD OF THE INVENTION

This invention relates to locks and seals for containers, in particular those including an automatic self-checking and warning system against tampering.

### BACKGROUND OF THE INVENTION

U.S. Pat. No. 4,262,284 discloses self-monitoring seals having fiber optic bundle loops with ends mounted in stressed tamper resistant containers, the seal being formed as a padlock with a shackle and display. A battery operates microelectronics to send coded light pulse sequences through the optic loop and to show a predetermined sequence on the display. Tampering with the container or interrupting or changing the light transmission through the fiber optic bundle disrupts the predetermined display sequence.

U.S. Pat. No. 4,322,721 discloses a self-checking warning or alarm installation containing an optical conductor or guide (optical fiber) as a signal line. The optical conductor together with an electronic monitoring circuit forms a free-running opto-electronic oscillator which comes to standstill when the oscillating optical signal is interrupted. An alarm or warning circuit associated with the monitoring circuit generates an alarm signal when this happens. The signal line may be of two parts, with light converter between them. The two parts may have aligned end faces such that the optical signal is interrupted upon misalignment.

U.S. Pat. No. 6,420,971 describes an electronic seal comprising a housing and a loop of optical fiber in an elongated closure member connectable at both of its ends to the housing. A sensor assembly is provided for sensing integrity of the optical fiber. Hence tampering with the seal can be detected. The optical path may include an air gap between the fiber end and the sensor so that opening of the seal may be also detected.

U.S. Pat. No. 4,546,345 discloses a lock with steel wire cable having an optical fiber (loop) inside the cable, which detects breaking of the cable (of the optical loop) and sounds an alarm when the cable is broken.

### SUMMARY OF THE INVENTION

In accordance with the present invention, there is provided a lock for locking a closure on a container, comprising a first member and a second member movable relative to one another, the two members being of strong construction, the lock having a closed state with the two members engaged with each other, and an open state with the two members disengaged, wherein the lock further comprises:
a control module with an infra-red (IR) emitter and an IR receiver;
an IR waveguide formed as an air channel carved in the body of the two members, starting at the IR emitter, ending at the IR receiver and passing through both members such that an IR pulse emitted by the IR emitter can pass through the waveguide and be received by the IR receiver only when the lock is in the closed state.

Preferably, the lock members are made of steel and the channel is machined therein. Preferably, the channel passes close to the outer edges of the lock members.

The control module further comprises a wireless transmitter and is adapted to transmit a warning signal to an external receiver when the IR receiver fails to receive the IR pulse emitted by the IR emitter. The IR pulse is preferably automatically emitted at predetermined intervals of time, more preferably with frequency of at least 2 Hz. The IR pulse may be modulated and encoded.

The lock further comprises a movable bolt adapted to assume a locking position where the bolt engages simultaneously the first and the second members in the closed state of the lock. Thereby the bolt prevents disengagement of the first and the second members. This state of the lock is defined as a locked state.

Preferably, the lock further comprises a movable blocking element adapted to assume a blocking position such that the bolt cannot be removed from its locking position without destruction.

In one embodiment of the lock, it further comprises a controllable drive adapted to move the blocking element to and from the blocking position. The drive may be a bi-stable solenoid.

In another embodiment of the lock (seal), the bolt comprises a breakable portion. The blocking element is adapted to assume the blocking position automatically after the bolt assumes its locking position such that the bolt can be removed from the locking position only by breaking the breakable portion.

Preferably, the blocking element comprises a portion of the IR waveguide formed such that the IR pulse can pass through the waveguide only in the blocked state of the lock.

The lock may further comprise a third member movably engaged to the first member and mounted to an element of the container. This element assumes a closed position when the closure is locked and an open position allowing opening of the closure. The IR waveguide and the third member of the lock are configured so that when the element is moved from its closed position towards its open position, with the lock still in its closed state, the third member moves with the element and obstructs the IR waveguide preventing passing of the IR pulse.

In yet another embodiment, the lock is formed as a padlock, wherein the first member is a U-shaped shackle with cylindrical ends. The shackle has an axial channel therealong with exits at the cylindrical ends, the channel constituting a part of the IR waveguide. The second member is a lock body accommodating the control module and the rest of the IR waveguide. The lock body has two recesses adapted to receive the cylindrical ends. The body and the cylindrical ends are formed so that when the ends are inserted in the recesses, the lock automatically assumes the closed state and the shackle may be released from the body only after being cut or broken into two separate parts.

The cylindrical ends have taper or bevel, and each end has a notch at the inner side of the U-shape. The body has a bore intersecting the recesses and two bolts sliding therein. The bolts are biased by a spring element towards the recesses, such that when the cylindrical ends enter the recesses, the taper or bevel pushes the bolt against the spring element into the bore to allow movement of the ends into the recesses. When the notches align with the bore, the bolts jump into the notches irreversibly locking the shackle to the body.

According to another aspect of the present invention, there is provided a seal for sealing a closure on a container, comprising a U-shaped shackle with cylindrical ends and a seal body having two recesses adapted to receive the cylindrical ends. The body and the cylindrical ends are formed so that when the ends are inserted in the recesses, the seal assumes an irreversibly closed state such that the shackle may be released from the body only after being cut or broken into two separate parts. The cylindrical ends have taper or bevel and a flat segment notch at the inner side of the U-shape. The body has a bore intersecting the recesses and two bolts sliding in said bore. The bolts are biased by a spring element towards the recesses, such that when the cylindrical ends enter the recesses, the taper or bevel pushes the bolt back into the bore to allow movement of the ends into the recesses. When the notches align with the bore, the bolts engage the notches, irreversibly locking said shackle to the body. As above, only when the shackle is broken into two separate parts, each part can be rotated to disengage the cylindrical end from the bolt so that the broken part may be pulled out of the body.

Preferably, the U-shaped shackle has a signal conducting means disposed along the U-shape and exiting at the cylindrical ends, and the seal body has an electronic control module with an emitter and a receiver of a signal, the control module being adapted, when the seal is in its closed state, to check periodically the integrity of the seal by emitting and receiving the signal through the signal conducting means.

The control module may further comprise a wireless transmitter adapted to transmit a warning signal to an external receiver when the signal receiver fails to receive the signal emitted by the signal emitter.

The signal conducting means may be an insulated electric wire, an optical fiber or an air channel conductive of IR light.

Preferably, the U-shaped shackle and the body are of strong construction, for example made of steel, such as steel tube. More preferably, the U-shaped shackle further comprises a plastic or rubber tube inserted in the steel tube.

Within the frame of this application, “strong construction” of a lock (seal) generally means that the lock is resistant to breaking/cutting at least as much as the closure or container on which the lock is used. If the lock (seal) is formed as a padlock, then “strong construction” would mean strength of a metal body and steel shackle.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1A is a schematic front view of a shipping container equipped with the lock/seal of the present invention.

FIG. 1B is a close-up of the lock/seal of FIG. 1A;

FIG. 2A is a bottom view of a lock of the present invention in open state;

FIG. 2B is a bottom view of the lock of FIG. 2 in closed state;

FIG. 3A is a back view of the lock of FIG. 1A in blocked state;

FIG. 3B is a back view of the lock of FIG. 1A in unblocked state;

FIG. 4A is a back view of a seal of the present invention in closed and blocked state;

FIG. 4B is a bottom view of one arm of the seal of FIG. 4A;

FIGS. 5A and 5B are respectively a side and a face view of the sealing element in the seal of FIG. 4A;

FIGS. 6A, 6B and 6C are top, side and front views of a split cam for mounting the lock/seal of the present invention;

FIGS. 7A and 7B show a breakable seal with strong shackle according to a second aspect of the invention;

FIGS. 8A and 8B are sectional views of the seal of FIG. 7 showing releasing of the shackle; and

FIG. 9 is an alternative shackle for the breakable seal of FIG. 7.

### DETAILED DESCRIPTION OF THE EMBODIMENTS

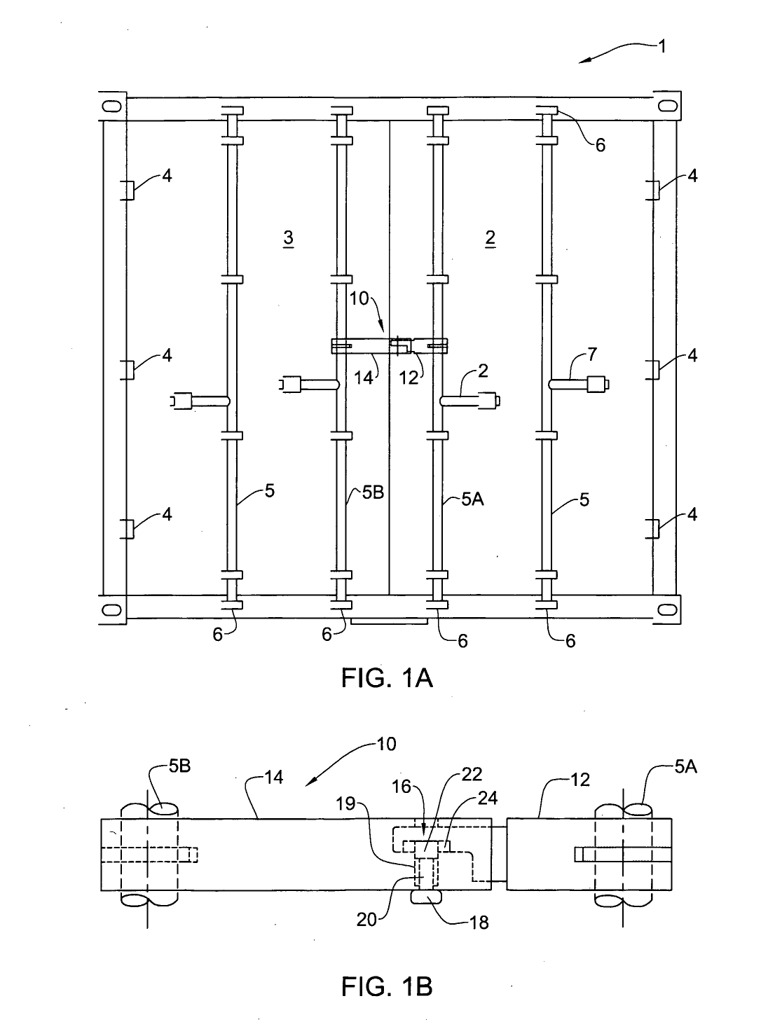

With reference to FIG. 1A, there is shown a face view of a shipping container 1 with doors 2 and 3. The doors are pivotable about hinges 4 and are secured in closed state by means of rods 5 engaged in braces 6. The rods 5 have handles 7 which may be turned inward (towards the middle of the container) to disengage the rods from the braces 6 and to release the doors 2 and 3.

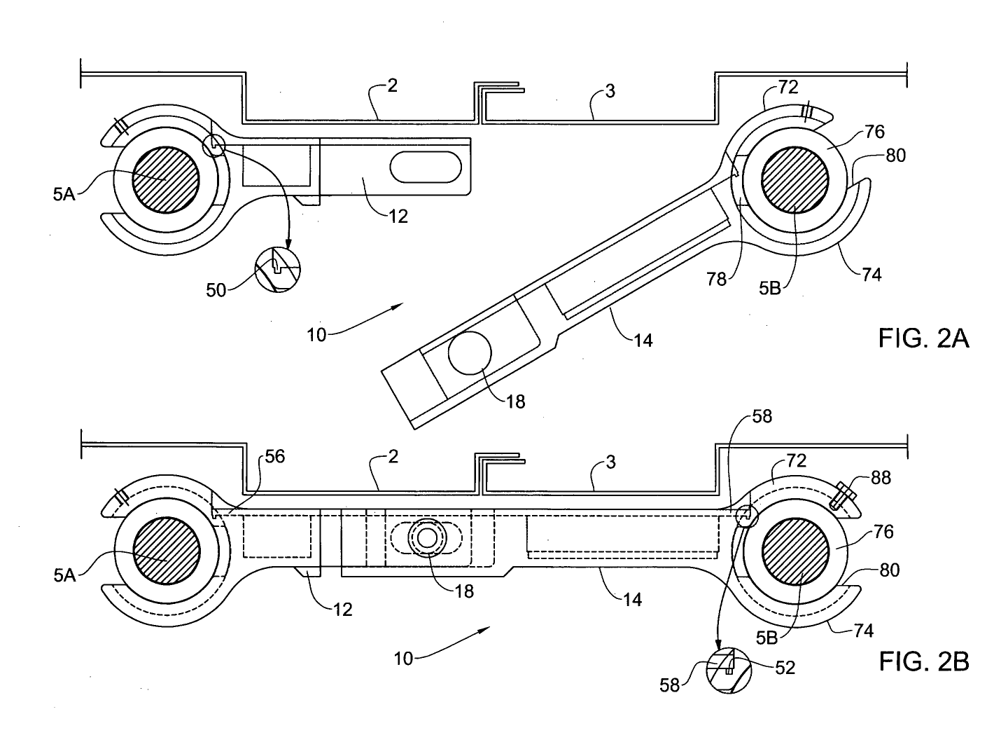

With reference also to FIGS. 1B, 2A and 2B, a lock 10 of the present invention comprises two arms 12 and 14 rotatably mounted on two rods 5A and 5B respectively. The mounting does not allow sliding of the arms down the rods 5 (see below a detailed description of the mounting). The lock 10 further comprises a movable bolt 16 with a knob 18, residing in a bore 19 of the arm 14 and adapted to engage the arm 12. When the bolt engages both arms, the lock 10 is in a closed state, the bolt is in locking position, and the doors 2 and 3 cannot be opened (FIG. 2B). When the bolt is disengaged from the arm 12, the lock 10 is in an open state allowing the doors 2 and 3 to be opened (FIG. 2A).

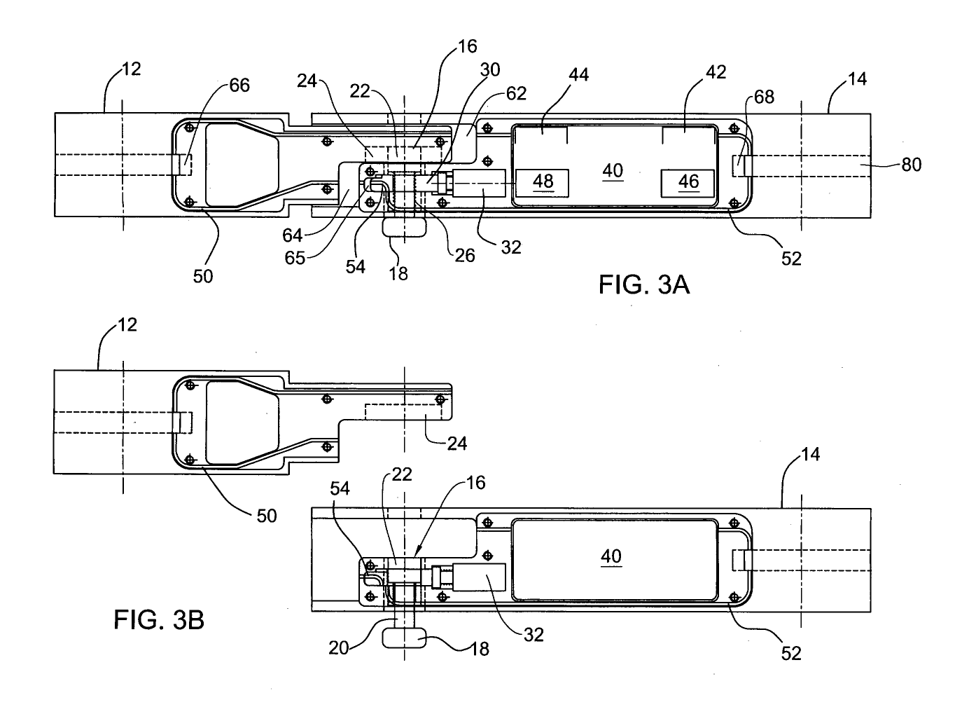

With reference also to FIGS. 3A and 3B showing a back view of the lock 10, the bolt 16 has a stem 20 and a head 22 forming a shoulder above the stem. The arm 12 has a recess 24 adapted to receive the head 22 while the arm 14 has a compression spring 26 urging the bolt into the recess 24.

The lock 10 further comprises a latch 30 mounted for sliding under the shoulder of the head 22 and coupled to a bi-stable solenoid 32. The latch 30 has a recess accommodating the stem 20. The solenoid 32 is adapted to toggle the latch between a blocking position engaging the head 22 such that the bolt 16 cannot be removed from its locking position without destruction (FIG. 3A), and an unblocking position allowing the bolt 16 to be pulled by the knob 18, and the head 22 to leave the recess 24.

The lock 10 further comprises an electronic control module 40 with an IR emitter 42, IR receiver 44, a wireless (RF) transmitter 46, a coded-signal receiver 48, other electronic circuitry, battery, etc. (not shown). An IR waveguide 50, 52, 54 is formed as a loop starting at the IR emitter 42 and ending at the IR receiver 44. One part 50 of the waveguide passes through the arm 12 while another part 52 passes through the arm 14 and a third part 54 passes through the latch 30. The waveguide has the form of a channel notched in the back surface of the arms 12 and 14, and in the latch 30. It is closed by a cover 56, 58 at the back of each arm 12, 14. The waveguide is interrupted by air gaps 62, 64 between the arms 12 and 14, air gap 65 between the latch 30 and the arm 14, and recesses 66, 68. In such places, the neighboring parts of the waveguide are aligned with each other and the channel of the waveguide approaches the arm surface at right angle so that an IR signal could pass across the air gap. Thus, when the lock 10 is in the closed state and the latch 30 is in the blocking position, an IR pulse emitted by the IR emitter 42 can pass through the waveguide 50, 52, 54 and be received by the IR receiver 44.

The operation of the lock of the present invention is as follows. Assume that initially the container 1 is with open doors 2 and 3, the arms 12, 14 of the lock 10 are disengaged, the latch 30 is toggled into the unblocking position and the bolt 16 is withdrawn (FIG. 3B).

An operator closes the doors 2 and 3, and secures the rods 5 in the braces 6 by rotating the handles 7 to an outward position. Now the operator rotates the arms 12 and 14 towards each other to align them as shown in FIGS. 1B and 2B. The recess 24 of the arm 12 is aligned with the bolt head 22. The operator pushes the knob 18, the bolt head 22 enters the recess 24, and the shoulder of the head 22 passes over the latch 30.

Now the operator uses a coded-signal transmitter (not shown) to send an access code for locking to the coded-signal receiver 48. The coded-signal communication may be in RF, IR, visible light, by electric contact, etc., or by vibration, as for example described in U.S. Pat. No. 6,411,195 to the same inventor. The control module 40 identifies the coded signal and operates the bi-stable solenoid 32 to toggle the latch 30 into its blocking position, as shown in FIG. 3A. Next, the control module starts periodical emission of IR pulses.

With the lock 10 in the closed state and the latch 30 in the blocking position, the waveguide parts 50, 52 and 54 are aligned with each other and the IR pulses are detected by the IR receiver 44. This is the normal state of the lock.

If for some reason IR pulses are not detected, the control module 40 activates the wireless transmitter 46 and sends an alert signal to a remote receiver (not shown). The remote receiver may be at the ship bridge, at a store house management room, police station, etc.

One condition for missing IR pulses is an open waveguide. This may happen when the lock is broken or the arms 12 and 14 are misaligned (the lock is not in closed state);

Another condition may be an interrupted waveguide. This may occur when the latch 30 is not in blocking position (see FIG. 3B).

Thus the lock detects and reports abnormal conditions indicative of attempts to break into the container, to tamper with the lock, or failure to lock the container properly.

When the container must be opened, the operator uses a coded-signal transmitter to send an access code for unlocking to the coded-signal receiver 38. The control module 30 operates the bi-stable solenoid 32 to toggle the latch 30 into unblocking position. The operator can now pull the knob 18 to withdraw the head 22 from the recess 24. Thus the arms 12 and 14 are disengaged. The handles 7 may be rotated inwards to release the rods 5 from the braces 6 and the doors 2 and 3 may be opened.

The coded-signal receiver 48 and the wireless transmitter 46, in the general case, are different devices and use different media for communication. For example, the coded-signal receiver may be even a keypad or a touch pad. However, in some applications they may be integrated, for example, in a single RF transmitter-receiver.

The waveguide may be formed so that other attempts to manipulate elements of the container can be detected. With reference to FIGS. 2A and 2B, the arms 12 and 14 are joined to the rods 5 by means of semi-circular jaws 72, 74 rotating about an intermediate cam 76. The cam 76 is secured to the rod 5 and has a tooth 78 received in a circular channel 80 of the jaws 72, 74. With reference to FIG. 3A, the circular channel 78 crosses the wave guide 52 on the arm 14 forming the air gap (recess) 68. When the arms 12 and 14 are in closed position, the tooth 78 is clear of the recess 68 and the IR pulse can pass through the gap (FIG. 2B). If an attempt is made to rotate the rod 5B inward (i.e. to release it from the braces 6), the tooth 78 will enter the recess 68 and will obstruct the waveguide 52. This relative position is seen in FIG. 2A.

Preferably, the lock arms are of strong construction, for example pressed or machined from steel, and the waveguide channel is also machined therein. The channel is preferably disposed close to external edges of the lock arms so that an attempt to break or cut the arms would first interrupt the channel.

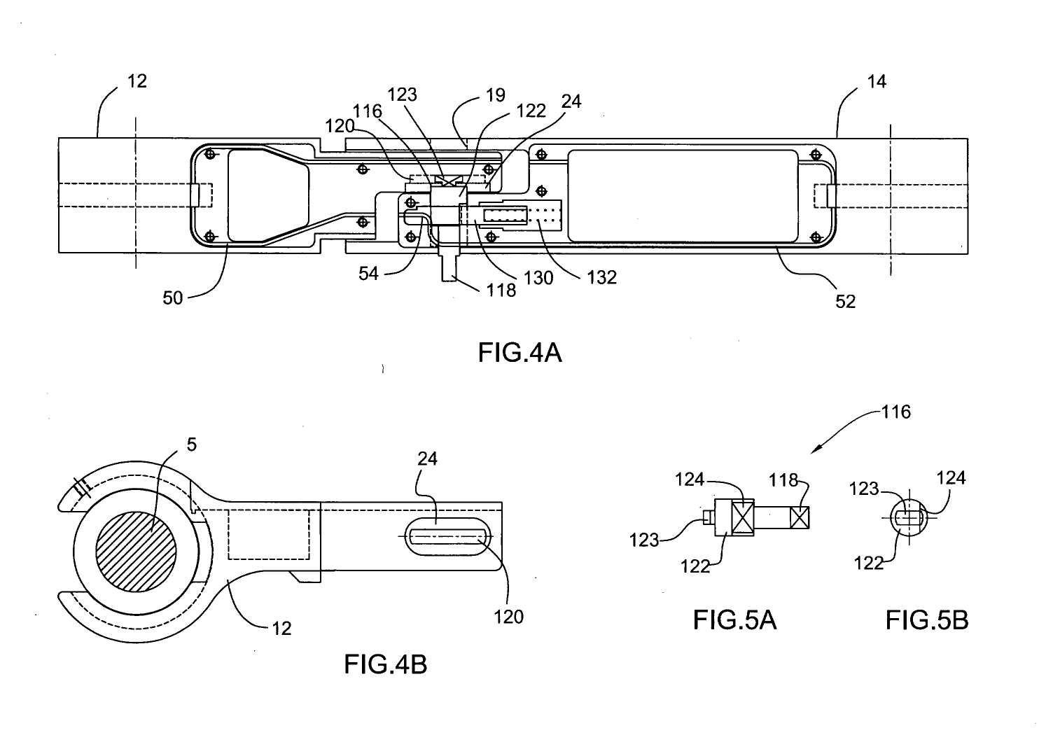

Another embodiment of the present invention is a sealing lock 100 shown in FIGS. 4A, 4B, 5A and 5B. Here the bolt is actually a seal 116 comprising a head 122 with a flat breakable portion 123 and a flat tail 118. The head 122 has a step 124 and a shoulder only at one side. The recess 24 has a narrow notch 120 adapted to receive only the flat breakable portion 123. A latch 130 is urged to its blocking position by means of a compression spring 132 instead of a bidirectional drive.

The sealing lock operates in the following way. The seal 116 is inserted into the bore 19 of the arm 14 before aligning with the arm 12, with the tail 118 forward, until the position of FIG. 4A is reached (but without the arm 12), with the step 124 and the shoulder of the head 122 abutting the latch 130. Then, using a key to hold the flat tail 118, the bolt 116 is rotated to about 90° so that the latch 130 is pushed against the spring 132 and releases the shoulder. The operator pulls the seal 116 further into the bore 19 until the breakable part 123 sinks into the bore. Then the operator aligns the arm 12 with the arm 14 so that the recess 24 is aligned with the bore 19. The seal 116 is rotated back and pushed up. The flat breakable part 123 is aligned with the notch 120 and received therein. The seal 116 assumes its locking position and the latch 130, urged by the spring 132, automatically jumps under the head 122 blocking the seal (FIG. 4A).

The flat part 123 of the seal 116 is now locked in the notch 120 and the seal cannot be rotated. Thus, the position of FIG. 4A is irreversible and the seal 116 can by removed from its locking position only after applying force on the tail 118 to break off the flat part 123.

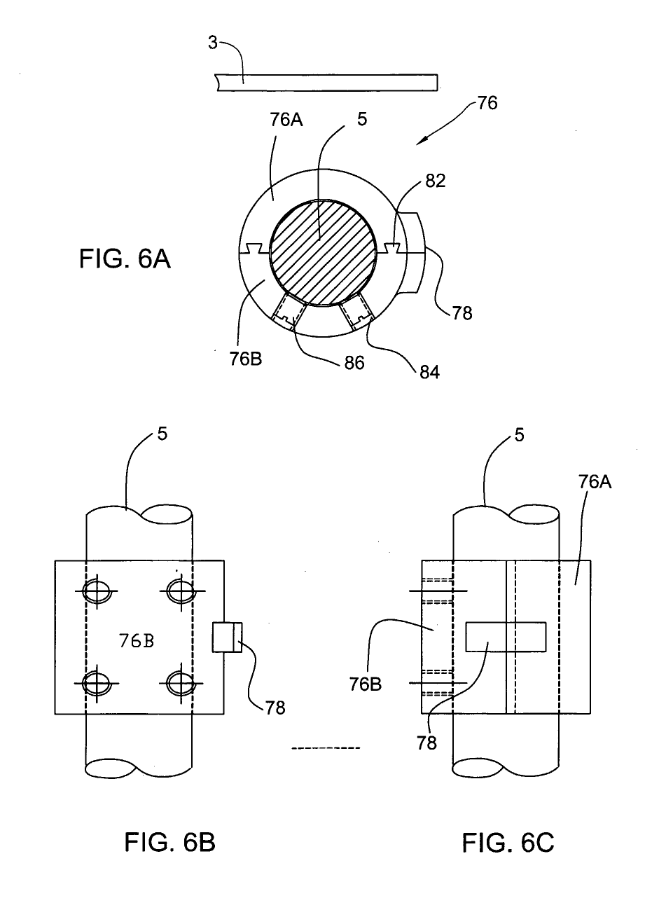

The mounting of the arms 12 and 14 on the rods 5 is shown in detail in FIGS. 6A, 6B and 6C. The intermediate cam 76 comprises two halves 76A and 76B coupled by a dovetail joint 82. One of the halves, 76B, has threaded bores 84 for set screws 86. The assembly of the cam 76 on the rod 5 is carried out as follows. The first half 76A is held in place between the rod 5 and the container wall. The second half 76B is born on the rod above or below the first half and the dovetail joint is engaged by axially sliding the second half in place. Now the set screws are tightened.

The rotary joint of the arms 12 and 14 with the cams 76 is assembled in the following way. An arm, for example the arm 12, is hanged on the rod 5 above or under the cam 76 and is rotated to 180° of its closed position so that the tooth 78 is axially aligned with the gap between the jaws 72 and 74. The arm 12 is moved along the rod axis until the tooth 78 is aligned with the channel 80. The arm 12 is now rotated to its closed position. The tooth 78 engages the channel 80 and prevents sliding of the arm along the rod 5. In order to avoid accidental rotation of the arm to the position where the tooth 78 may fall into the gap between the jaws 72 and 74, a bolt 88 is screwed into the jaw 72 so that its tip abuts the tooth 78.

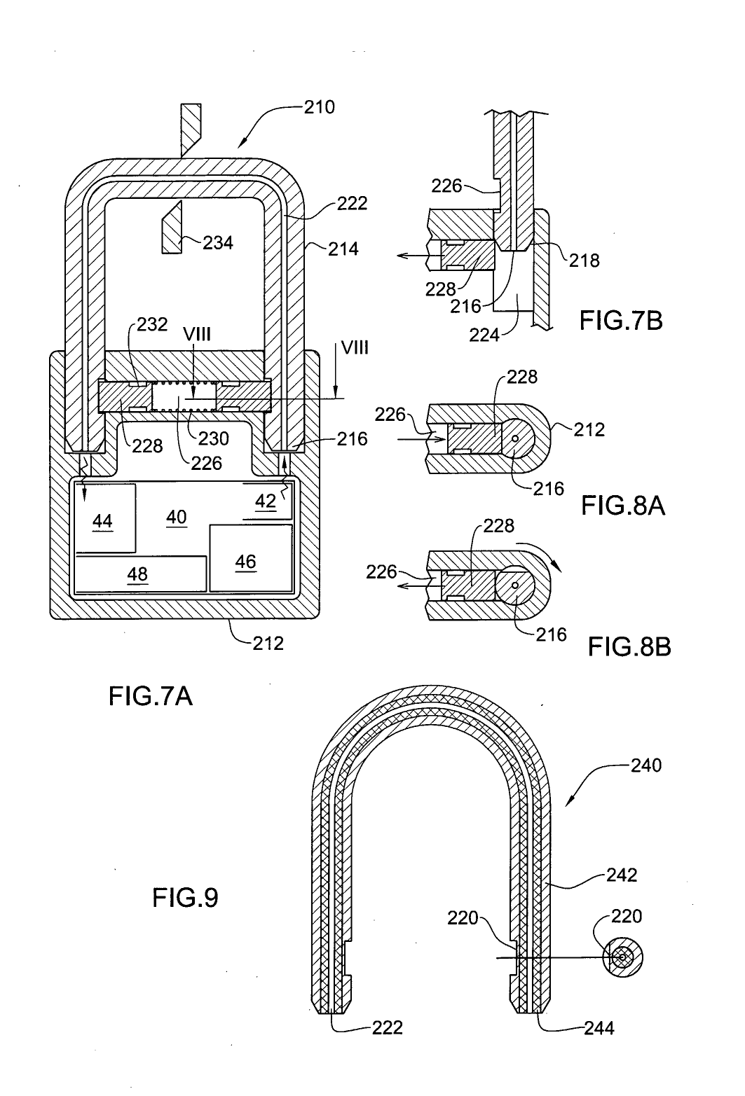

With reference to FIG. 7A, there is shown a seal 210 according to another aspect of the present invention. The seal 210 comprises a seal body 212 and a U-shaped shackle 214.

The shackle 214 has two ends 216 with taper or bevel 218 and notches 220 at the inner side of the U-shape. Furthermore, the shackle has a central channel (waveguide) 222 extending along the U-shape and exiting at the faces of the ends 216.

The body 212 has two cylindrical bores 224 for accommodating the ends 216, and a transverse cylindrical bore 226 with two bolts 228 sliding therein and biased outwards by a spring 230. The bolts 228 have notches 232 engaged with stoppers (not shown) protruding inside the bore 226 so as to limit the axial travel of the bolts 228 either way. An electronic control module 40 similar to the one described with reference to FIG. 3A comprises an IR emitter 42, IR receiver 44, a wireless (e.g. RF) transmitter 46, a coded-signal receiver 48, and other electronic circuitry.

The operation of the seal 210 is as follows. The shackle 214 is first passed through suitable openings in a container cover, a door or any enclosure that has to be sealed. The ends 216 of the shackle 214 are then inserted in the bores 224 of the seal body 212. With reference to FIG. 7B, the bevel 218 urges the bolt 228 into the bore 226 so that the shackle can enter the body 212 all the way down the bores 224. When the notch 220 comes entirely opposite the bolt 228, the latter jumps into the notch urged by the spring 230 and locks the shackle 214 to the body 212 (this position is shown in FIGS. 7A and 8A).

The locked state of the seal is irreversible, e.g. the seal cannot be opened without being broken, as the spring 230 does not allow bolts 228 to leave the notches 220 and release the shackle 214. In this state, the exits of the waveguide 222 are aligned with the IR emitter 42 and the IR receiver 44 so that the integrity of the seal may be checked by sending and detecting IR pulses as described above.

When the locked enclosure has to be legitimately opened, a powerful cutting tool 234 is used to cut or break the shackle 214 into two separate parts. Now each part can be rotated in its cylindrical bore 224. As shown in FIG. 8B, by way of rotation to about 90°, the end 216 pushes the bolt 228 back into the bore 226 so that the shackle part may be pulled out of the seal body 212. For the next sealing, a new shackle 214 is used.

With reference to FIG. 9, a composite shackle 240 is shown which is made of an external steel tube 242 and a rubber or plastic internal tube 244 accommodating the waveguide channel 222. While the external tube is strong, the internal tube is soft and tends to close the waveguide upon slight deformation which may occur at an attempt to break the shackle. The steel tube may be bent and thermally hardened before the soft tube is inserted. The strength of the shackle can be adapted to the purpose of application by selecting the shackle diameter, steel grade, hardening, etc.

The seal 210 may be used not only with IR light but may be built with an optical fiber, electric wire or other type of conductor.

1-23. (canceled)

24. A seal for sealing a closure on a container, comprising a U-shaped shackle with cylindrical ends and a seal body having two recesses adapted to receive said cylindrical ends, said body and said cylindrical ends being formed so that when said ends are inserted in said recesses, the seal assumes an irreversibly closed state such that said shackle may be released from said body only after being cut or broken into two separate parts, wherein
said cylindrical ends have taper or bevel and a flat segment notch at the inner side of the U-shape, said body has a bore intersecting said recesses and two bolts sliding in said bore, said bolts being biased by a spring element towards said recesses, such that when said cylindrical ends enter said recesses, said taper or bevel pushes said bolt against said spring element into said bore to allow movement of said ends into said recesses and when said notches align with said bore said bolts engage said notches, irreversibly locking said shackle to said body,
and such that when said shackle is broken into two separate parts, each part can be rotated, whereby said flat segment notch pushes said bolt back into said bore and disengages said cylindrical end from said bolt so that said part may be pulled out of said body.

25. The seal of claim 24, wherein said U-shaped shackle has a signal conducting means disposed along said U-shape and exiting at said cylindrical ends, and said seal body has an electronic control module with an emitter and a receiver of a signal, said control module being adapted, when said seal is in its closed state, to check periodically the integrity of said seal by emitting and receiving said signal through said signal conducting means.

26. The seal of claim 25, wherein said control module further comprises a wireless transmitter and is adapted to transmit a warning signal to an external receiver when said signal receiver fails to receive said signal emitted by said signal emitter.

27. The seal of claim 25, wherein said signal conducting means is an insulated electric wire.

28. The seal of claim 25, wherein said signal conducting means is an optical fiber.

29. The seal of claim 25, wherein said signal conducting means is an air channel conductive of IR light.

30. The seal of claim 25, wherein said U-shaped shackle and said body are of strong construction.

31. The seal of claim 30, wherein said U-shaped shackle is made of steel.

32. The seal of claim 31, wherein said U-shaped shackle is made of a bent steel tube.

33. The seal of claim 32, wherein said U-shaped shackle further comprises a plastic or rubber tube inserted in said steel tube.

34. A lock for locking a closure on a container, comprising a first member and a second member movable relative to one another, said two members being of strong construction, the lock having a closed state with the two members engaged with each other, and an open state with the two members disengaged, wherein said lock further comprises:
a control module with an IR (infrared) emitter and an IR receiver;
an IR waveguide formed as an air channel carved in the body of said two members, starting at said IR emitter, ending at said IR receiver and passing through said two members such that an IR pulse emitted by said IR emitter can pass through said waveguide and be received by said IR receiver only when said lock is in said closed state.

35. The lock of claim 34, wherein said control module further comprises a wireless transmitter and is adapted to transmit a warning signal to an external receiver when said IR receiver fails to receive said IR pulse emitted by said IR emitter.

36. The lock of claim 35, wherein said IR pulse is automatically emitted at predetermined intervals of time.

37. The lock of claim 36, wherein said IR pulse is emitted with frequency of at least 2 Hz.

38. The lock of claim 34, further comprising a movable bolt adapted to assume a locking position where said movable bolt engages simultaneously said first and second members in said closed state of the lock thereby preventing disengagement of said first and second members and defining a locked state of said lock.

39. The lock of claim 38, further comprising a movable blocking element adapted to assume a blocking position such that said bolt cannot be removed from its locking position without destruction.

40. The lock of claim 39, further comprising a controllable drive adapted to move said blocking element to and from said blocking position.

41. The lock of claim 39, wherein said bolt comprises a breakable portion and said blocking element is adapted to assume said blocking position automatically after said bolt assumes said locking position such that said bolt can be removed from said locking position only by breaking said breakable portion.

42. The lock of claim 41, wherein said blocking element comprises a portion of said IR waveguide formed such that said IR pulse can pass through said waveguide only in said blocked state of the lock.

43. The lock of claim 34, wherein said IR waveguide passes close to outer edges of said two members.

44. The lock of claim 34, further comprising a third member movably engaged to said first member, said third member being mounted to an element of said container, said element assuming a closed position when said closure is locked and an open position allowing opening of said closure, said IR waveguide and said third member being configured so that when said element is moved from its closed position towards its open position, and said lock is in said closed state, said third member moves with said element and obstructs said IR waveguide preventing passing of said IR pulse.

45. The lock of claim 34, wherein said first member is a U-shaped shackle with cylindrical ends, said shackle having an axial channel therealong with exits at said cylindrical ends, said channel constituting a part of said IR waveguide, said second member being a lock body accommodating said control module and the rest of said IR waveguide and having two recesses adapted to receive said cylindrical ends, said body and said cylindrical ends being formed so that when said ends are inserted in said recesses, the lock automatically assumes said closed state and said shackle may be released from said body only after being cut or broken into two separate parts.

46. The lock of claim 45, wherein said cylindrical ends have taper or bevel, and each end has a notch at the inner side of the U-shape, said body has a bore intersecting said recesses and two bolts sliding in said bore, said bolts being biased by a spring element towards said recesses, such that when said cylindrical ends enter said recesses, said taper or bevel pushes said bolt against said spring element into said bore to allow movement of said ends into said recesses and when said notches align with said bore said bolts jump into said notches irreversibly locking said shackle to said body whereby said lock automatically assumes said closed state.
